(19) United States
(12) Patent Application Publication
(10) Pub. No.: US 2017/0111799 A1
(43) Pub. Date: Apr. 20, 2017

(54) A Method for Barrier-free Access to Wireless Network

(71) Applicant: BEIJING GEEK-GEEK TECHNOLOGY CO., LTD., Beijing (CN)

(72) Inventor: Xinggu Zheng, Beijing (CN)

(21) Appl. No.: 15/127,989

(22) PCT Filed: May 12, 2015
(86) PCT No.: PCT/CN2015/078716

§ 371 Date: Sep. 21, 2016

(30) Foreign Application Priority Data
Dec. 15, 2014 (CN) 201410778338.X

(51) Int. Cl. H04W 12/08; H04L 29/06; H04W 12/06; H04W 76/02; H04W 12/04

(52) U.S. Cl. CPC H04W 12/08; H04W 76/02; H04W 12/04; H04W 12/06; H04L 63/061; H04L 63/0876; H04W 92/10

(57) ABSTRACT

The present invention relates to a method for barrier-free access to wireless network. This method comprises the following steps: in the various wireless device to be accessed, a separate pre shared key (V-PSK) corresponding to their MAC address is set, and the above MAC address, the separate pre shared key (V-PSK) and their corresponding relationship are saved in the access point device; in the process of the handshaking between the wireless device and the access point device, both the wireless device and the access point device use the said separate pre shared key V-PSK to calculate a check value, and judge whether the two check values are same to confirm to allow access or reject access.

### FIELD OF THE INVENTION

The present invention relates to a method for barrier-free access to wireless network, and particularly relates to a method for supporting multiple pre shared keys, when encrypting in WPA/WPA2 protocol.

### BACKGROUND OF THE INVENTION

Because wireless network uses an open medium, and public electromagnetic wave is used as a carrier to transmit data signals, two communication ends do not have cable connection. If the transmission link fails to take proper encryption protection, the risk of data transmission will be greatly increased. There are three common wireless network encryption methods, namely, WEP encryption method, WPA/WPA2 enterprise edition is encryption mode, WPA/WPA2 Personal Edition encryption mode. Due to the low security of WEP, more and more users have chosen to use the WPA/WPA2 enterprise edition encryption mode or personal version of the encryption method. In general, for home users, all use WPA/WPA2's personal edition. This WPA personal edition uses a pre shared key, all devices access to the network must use the shared key for authentication and access to the network. After the wireless access hotspot devices in the network, such as a wireless router modifies the key, all devices access to the network that have the original set need to reset the key. This is a complex and cumbersome problem for wireless printers, wireless speakers, and other devices that have no user interface. Currently on the market, default wireless set up of factory set up of wireless access hotspot devices, such as a wireless router, has no encryption mode, before use by the user to set the wireless encryption mode and wireless key. If manufacturers want to sell a wireless router and wireless printers or wireless speakers in combination with a variety of device set to the user, even if manufacturers set in advance that wireless printers or wireless speakers bind the wireless router, when the user modified the wireless key of the wireless router, these already bound to the relationship between wireless printers or wireless speakers still need to reset the wireless key to access the wireless router that has changed the wireless key.

Thus there is such a requirement, that is, when the user modifies the wireless key to access the hot spot, the original device which has connected to the wireless hot spot can be automatically connected to the new network without any configuration. Sellers canset to push a combination package of a variety of different wireless devices, and when a user absolutely changes the wireless key of the access point, these devices can optionally access barrier free, so as to make the user more convenient to experience the wireless network.

### SUMMARY OF THE INVENTION

For the above technical problem, the present invention provides a method for barrier-free access to wireless network, including the steps:

in the various wireless device to be accessed, a separate pre shared key (V-PSK) corresponding to their MAC address is set, and the above MAC address, the separate pre shared key (V-PSK) and their corresponding relationship are saved in the access point device,

in the process of the handshake between the wireless device and the access point device,

the wireless access point (AP) randomly generates an access point random data (ANonce) and transmits it to the wireless device (STA);

the said wireless device randomly generates a wireless devices random data (SNonce), a wireless device end check value (S-MIC) is generated by the received access point random data (ANonce), the said wireless device random data (SNonce), and their own held separate pre shared key (V-PSK) corresponding to their MAC address, and the said wireless device random data (SNonce) and the said wireless device end check value (S-MIC) are sent to a wireless access point;

the said wireless access point device achieves the separate pre shared key (V-PSK) corresponding to the MAC address by the MAC address of the wireless devices to be accessed, and an access end check value (A-MIC) is generated by the said access point random data (ANonce), the received wireless device random data (SNonce), as well as the above separate pre shared key (V-PSK); when the wireless device end check value (S-MIC) is same as the access end check value (A-MIC), the other connection information is sent to the said wireless device, otherwise the wireless access point rejects the access of the said wireless device;

the said wireless device transmits a confirmation message to the said wireless access point.

Preferably, in the above method for barrier-free access to wireless network, the separate pre shared key (V-PSK) of each of the different wireless devices is different.

Preferably, in the above method for barrier-free access to wireless network, during the handshake process of the wireless device and the access point device, the EAPOL-KEY frame format is used for data exchange.

Preferably, in the above method for barrier-free access to wireless network, the steps that an checksum is generated by the said access point random data (ANonce), the said wireless device random data (SNonce), as well as the above separate pre shared key (V-PSK), including:

the said separate pre shared key (V-PSK) is converted to a management key (PMK) in accordance with the provisions of the WPA/WPA2 protocol,

by the input of the said access point random data (ANonce), the said wireless device random data (SNonce) and the above management key (PMK), a data encryption key (PTK) is generated in accordance with the provisions of the WPA/WPA2 protocol,

in accordance with the provisions of WPA/WPA2 protocol, the above data encryption key (PTK) is calculated into an access end check value (A-MIC) or a wireless device end checksum (S-MIC) that contains the frame of the said wireless device random data (SNonce).

Preferably, in the above method for barrier-free access to wireless network, on the said access point device, the said wireless device and the pre shared key (C-PSK) that a user sets, when the access point device or the wireless device failed to find the separate pre shared key (V-PSK), the pre shared key (C-PSK) will be replaced by the above pre shared key (C-PSK) to generate an access end check value (A-MIC) or a wireless device end check value (S-MIC).

Preferably, in the above method for barrier-free access to wireless network, the said access point device is a wireless router.

Preferably, in the above method for barrier-free access to wireless network, the said wireless device to be accessed is a wireless printer, a wireless speaker, an intelligent socket, a universal remote controller or a TV box.

Preferably, in the above method for barrier-free access to wireless network, the said access point device and the wireless device to be accessed are matched.

The present invention is very convenient for the safe wireless connection between the devices which have the binding relationship. Generally factory default of a wireless access point device is no encryption mode, and a user himself can set an encryption mode and key. Even if factory default of some devices is to set a key, because the key is not set by a user and it is also very hard to remember some irregular characters for the user, the user still have to change the key, and the user in the course of daily use may also need to modify the wireless key. In the prior art, after the user modifies the key, the original access network devices all need to set the key again to access the network again, and a wireless printer, a wireless speakers, a TV box, etc. must reset a key by a wireless access network device. But if the method of the invention is used, these wireless printers, wireless speakers, TV boxes, etc., are not affected by the user to modify the wireless key if the special pre shared key access network is used. On the other hand, the use of these special pre shared keys is bound with the device's MAC address. Other devices using the pre shared keys are unable to access the network. So it is safe, and it is not necessary for the user to set.

### BRIEF DESCRIPTION OF THE DRAWINGS

FIG. 1 is a view, showing the interaction process between a wireless device and an access point device according to an embodiment of the present invention;

FIG. 2 is a flow chart, showing an access point device generates an access end check value A-MIC.

### DETAILED DESCRIPTION OF THE PREFERRED EMBODIMENTS

Hereinafter, the said method for barrier-free access to wireless network of the present invention will be described with reference to the drawings in embodiments of the present invention.

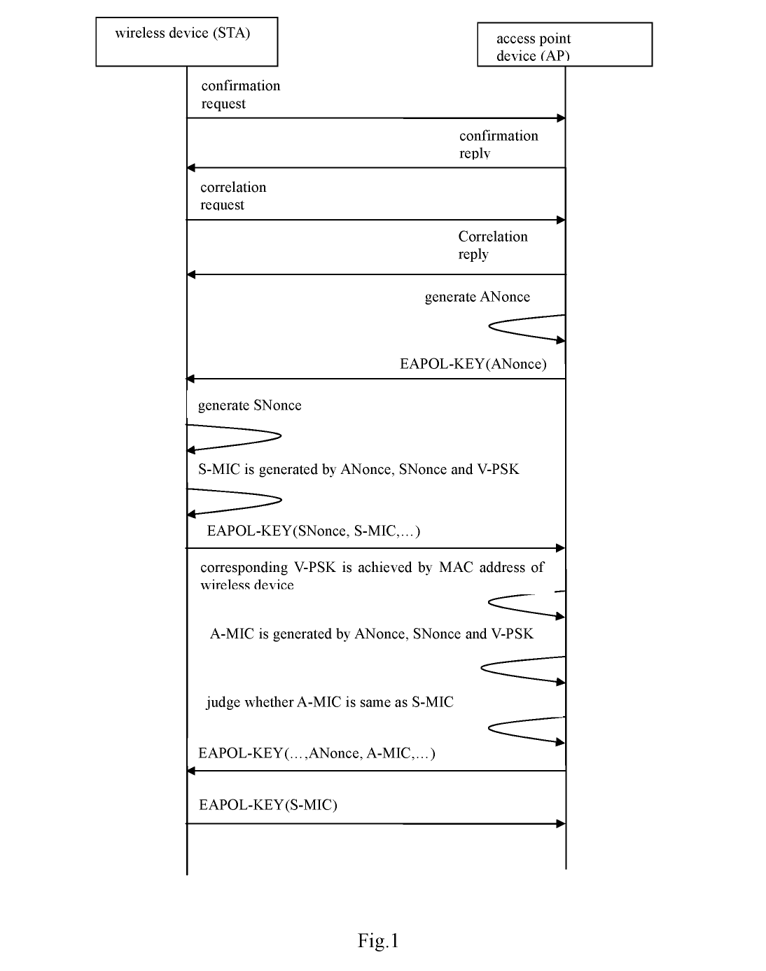

Referring to FIG. 1, in an embodiment according to the invention, the related access point device AP is a wireless router, the related wireless devices STA to be accessed to the network are respectively a wireless printer and a wireless speaker.

When the two devices are in the factory, the wireless printer will be preinstalled with a separate pre shared key V-PSK1 corresponding to its MAC address Mac-1, and the wireless speaker will be preinstalled with a separate pre shared key V-PSK2 corresponding to its MAC address Mac-2. And a corresponding table with their MAC addresses and respective pre shared key V-PSK will be saved in the wireless router.

The said wireless router, wireless printer and the wireless speaker are bundled to be sold, and used cooperatively in the practical application

In order to access the network, the interaction process between the wireless printer or wireless speaker and the wireless router is divided into two sections: the authentication association process and the four handshaking process, wherein the authentication process is to inform the two parties that the two devices have the communication ability, which is independent of the key.

However, the four handshaking process is to verify whether the key of the two parties is same, and to negotiate the data encryption key used in the follow-up communication process. In the four handshaking process, the mode of EAPOL-KEY frame is used to exchange data.

As shown as FIG. 1, the four handshaking process comprises:

the wireless access point AP randomly generates a data ANonce and transmits it to the wireless device STA in the mode of EAPOL-KEY frame.

the wireless device STA randomly generates a data SNonce after receiving the above data, a wireless device end check value S-MIC is generated by the received access point random data ANonce, the said wireless device random data SNonce, and the their own held separate pre shared key V-PSK (the key of the wireless printer is V-PSK1, the key of the wireless speaker is V-PSK2) corresponding to their MAC address, and the said wireless device random data SNonce and the said wireless device end check value S-MIC are sent to a wireless access point AP in the mode of EAPOL-KEY frame.

After the wireless access point device AP receives the above data, the MAC address of the invalid device is extracted from the request access, and the separate pre shared key V-PSK (the key of the wireless printer is V-PSK1, the key of the wireless speaker is V-PSK2) corresponding to the wireless device is found in the corresponding table with their MAC addresses and respective pre shared key. Hereinafter, the wireless access point device uses the access point random data ANonce, the received wireless device random data SNonce, as well as the found separate pre shared key V-PSK corresponding to the MAC address of the said wireless device to generate an access end check value A-MIC; and judges whether the access end check value A-MIC is same as the received wireless device end check value S-MIC, if yes, the data including the access point random data ANonce and the access end check value A-MIC is sent to the said wireless device STA in the mode of EAPOL-KEY frame.

After the wireless device receives the above data, it transmits the wireless device end check value S-MIC to the wireless access point in the mode of EAPOL-KEY frame.

In the above handshaking process, the process that a check value is generated by the access point random data ANonce, the wireless device random data SNonce and the separate pre shared key V-PSK is in accordance with the provisions of the WPA/WPA2 protocol, or in another way.

Meanwhile, in order to be Compatible with the current WPA/WPA2 protocols, on the above access point device and the wireless device to be accessed, a pre shared key (C-PSK) will be set by a user.

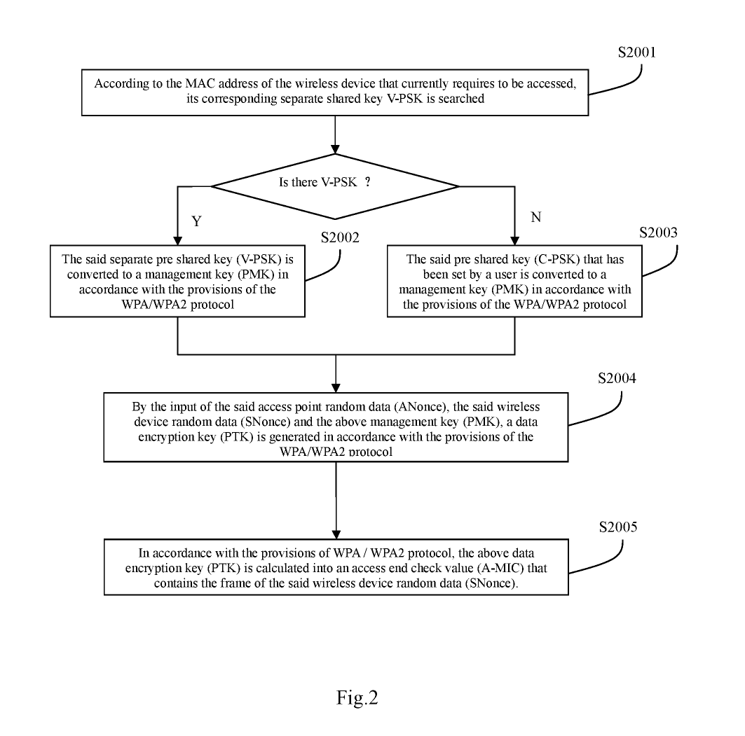

In an embodiment according to the invention of FIG. 2, a process for generating a check value A-MIC by a wireless router of an access point device provided with a pre shared key (C-PSK) set by a user, wherein the steps including:

Step S2001: according to the MAC address of the wireless device that currently requires to be accessed, its corresponding separate shared key V-PSK is searched.

For example, if the wireless device that currently requires to be accessed is a wireless printer whose MAC address is Mac-1, the separate shared key picked up from its corresponding table by the wireless router is V-PSK1. If the wireless device that currently requires to be accessed is a wireless speaker whose MAC address is Mac-2, the separate shared key picked up from its corresponding table by the wireless router is V-PSK2. It may be a TV box whose MAC address is Mac-3, and there is not its corresponding V-PSK in its corresponding table.

If the corresponding separate shared key can be found, Step S2002 will be executed. For example, the above wireless printer and wireless speaker. If the corresponding separate shared key can't be found, Step S2003 will be executed. For example, the above TV box.

Step S2002: the said separate pre shared key (V-PSK) is converted to a management key (PMK) in accordance with the provisions of the WPA/WPA2 protocol.

Step S2003: the said pre shared key (C-PSK) that has been set by a user is converted to a management key (PMK) in accordance with the provisions of the WPA/WPA2 protocol.

That is, if the corresponding separate shared key can be found, a management key (PMK) is generated by the separate shared key. If not, a management key (PMK) is generated by the pre shared key. After generating a management key (PMK), Step S2004 and Step S2005 will be executed.

Step S2004: by the input of the said access point random data (ANonce), the said wireless device random data (SNonce) and the above management key (PMK), a data encryption key (PTK) is generated in accordance with the provisions of the WPA/WPA2 protocol.

Step S2005: in accordance with the provisions of WPA/WPA2 protocol, the above data encryption key (PTK) is calculated into an access end check value (A-MIC) that contains the frame of the said wireless device random data (SNonce).

For wireless devices that need to be accessed, the calculation method of the check value is similar to that of the above. If it itself holds a separate pre shared key (V-PSK), the separate pre shared key (V-PSK) is converted to a management key (PMK) in accordance with the provisions of the WPA/WPA2 protocol. If it does not hold a separate pre shared key (V-PSK), the management key (PMK) is generated by the pre shared key (C-PSK) that has been set by a user. And the other processing processes are same.

The above stated is only preferable embodiments of the present invention, and it should be noted that the above preferable embodiments do not limit the present invention. The claimed scope of the present invention should be based on that defined by the claims. For a skilled person in this technical field, without departing from spirit and scope of the present invention, any improvement and amendment can be made, and these improvement and amendment should belong to the claimed scope of the present invention.

1. A method for barrier-free access to wireless network, including the steps:
in the various wireless device to be accessed, a separate pre shared key (V-PSK) corresponding to their MAC address is set, and the above MAC address, the separate pre shared key (V-PSK) and their corresponding relationship are saved in the access point device;
in the process of the handshake between the wireless device and the access point device,
the wireless access point (AP) randomly generates an access point random data (ANonce) and transmits it to the wireless device (STA);
the said wireless device randomly generates a wireless devices random data (SNonce), a wireless device end check value (S-MIC) is generated by the received access point random data (ANonce), the said wireless device random data (SNonce), and their own held separate pre shared key (V-PSK) corresponding to their MAC address, and the said wireless device random data (SNonce) and the said wireless device end check value (S-MIC) are sent to a wireless access point;
the said wireless access point device achieves the separate pre shared key (V-PSK) corresponding to the MAC address by the MAC address of the wireless devices to be accessed, and an access end check value (A-MIC) is generated by the said access point random data (ANonce), the received wireless device random data (SNonce), as well as the above separate pre shared key (V-PSK); when the wireless device end check value (S-MIC) is same as the access end check value (A-MIC), the other connection information is sent to the said wireless device, otherwise the wireless access point rejects the access of the said wireless device;
the said wireless device transmits a confirmation message to the said wireless access point.

2. The method for barrier-free access to wireless network according to the claim 1, characterized in that, the separate pre shared key (V-PSK) of each of the different wireless devices is different.

3. The method for barrier-free access to wireless network according to the claim 1, characterized in that, during the handshake process of the wireless device and the access point device, the EAPOL-KEY frame format is used for data exchange.

4. The method for barrier-free access to wireless network according to the claim 1, characterized in that, the steps that a check value is generated by the said access point random data (ANonce), the said wireless device random data (SNonce), as well as the above separate pre shared key (V-PSK), including:
the said separate pre shared key (V-PSK) is converted to a management key (PMK) in accordance with the provisions of the WPA/WPA2 protocol, by the input of the said access point random data (ANonce), the said wireless device random data (SNonce) and the above management key (PMK), a data encryption key (PTK) is generated in accordance with the provisions of the WPA/WPA2 protocol,
in accordance with the provisions of WPA/WPA2 protocol, the above data encryption key (PTK) is calculated into an access end check value (A-MIC) or a wireless device end checksum (S-MIC) that contains the frame of the said wireless device random data (SNonce).

5. The method for barrier-free access to wireless network according to the claim 1, characterized in that, on the said access point device, the said wireless device and the pre shared key (C-PSK) that a user sets, when the access point device or the wireless device failed to find the separate pre shared key (V-PSK), the pre shared key (C-PSK) will be replaced by the above pre shared key (C-PSK) to generate an access end check value (A-MIC) or a wireless device end check value (S-MIC).

6. The method for barrier-free access to wireless network according to the claim 1, characterized in that, the said access point device is a wireless router.

7. The method for barrier-free access to wireless network according to the claim 1, characterized in that, the said wireless device to be accessed is a wireless printer, a wireless speaker, an intelligent socket, a universal remote controller or a TV box.

8. The method for barrier-free access to wireless network according to the claim 1, characterized in that, the said access point device and the wireless device to be accessed are matched.
